(19) United States
(12) Patent Application Publication
(10) Pub. No.: US 2019/0028493 A1
(43) Pub. Date: Jan. 24, 2019

(54) ATTACK MONITORING SYSTEM AND ATTACK MONITORING METHOD

(71) Applicant: TOYOTA JIDOSHA KABUSHIKI KAISHA, Toyota-shi (JP)

(72) Inventors: Toshiki ENDO, Shiki-shi (JP); Takafumi NISHIYAMA, Anjo-shi (JP)

(73) Assignee: TOYOTA JIDOSHA KABUSHIKI KAISHA, Toyota-shi (JP)

(21) Appl. No.: 16/035,053

(22) Filed: Jul. 13, 2018

(30) Foreign Application Priority Data
Jul. 19, 2017 (JP) 2017-139770

(51) Int. Cl. H04L 29/06; G06F 17/30; H04W 4/40

(52) U.S. Cl. CPC H04L 63/1416; H04L 61/6022; H04W 4/40; G06F 17/30876

(57) ABSTRACT

An attack monitoring system comprises a server device; and a plurality of communication devices constituting a wireless communication network, wherein the server device includes an information acquirer that acquires, in a case where an attack is performed on a mobile unit connected to the wireless communication network, attacker information serving as information related to a transmission source of the attack; and an information sharer that causes the plurality of communication devices to share the attacker information, and each of the plurality of communication devices blocks communication transmitted from the transmission source which corresponds to the shared attacker information.

### CROSS REFERENCE TO RELATED APPLICATION

This application claims the benefit of Japanese Patent Application No. 2017-139770, filed on Jul. 19, 2017, which is hereby incorporated by reference herein in its entirety.

### BACKGROUND OF THE INVENTION

### Field of the Invention

The present invention relates to an attack monitoring technique in a network.

### Description of the Related Art

In recent years, it is studied to provide various services by providing a vehicle with a wireless communication function and causing the vehicle to perform wireless communication with a server device or other vehicles. It is assumed that a mobile telephone network or a public wireless LAN is used as a wireless communication network.

On the other hand, when the vehicle is connected to the Internet, a CAN or an ECU in the vehicle may be attacked from an external network via a vehicle-mounted device or the like.

To cope with such an attack on the vehicle in a car telematics environment, there are proposed a countermeasure in which the reliability of a communication source is secured by executing authentication on the side of the vehicle-mounted device, and a countermeasure in which encryption is performed when data is transmitted or received (Japanese Patent Application Publication No. 2013-157693 and Japanese Patent Application Publication No. 2013-98719).

In addition, Japanese Patent Application Publication No. 2015-207912 discloses a technique which, after detecting an attack by false information based on notification timing, prevents other terminals from receiving the false information by transmitting an interfering signal based on data generated using a pseudo-random number such that the false information cannot be received.

By using such a technique, it is possible to block unauthorized communication in a network.

### SUMMARY OF THE INVENTION

However, in the car telematics environment, an indiscriminate attack can be performed on a plurality of vehicles. In such a case, not all of the target vehicles can cope with the attack perfectly.

On the other hand, there is known a technique which, in the case where an attack transmitted from the outside of a network is detected, blocks corresponding communication at a gateway such that unauthorized communication dose not enter the network. However, the car telematics environment uses a public communication network, and hence there are cases where the attack is transmitted from the inside of the communication network. In addition, such an attack can be transmitted from various locations, and hence it is difficult to block the attack at a specific gateway.

That is, the conventional art cannot adequately cope with the attack that can be performed on the vehicle.

The present invention has been made in view of the above problem, and an object thereof is to block unauthorized communication to a mobile unit in a mobile communication network in which a plurality of the mobile units perform wireless communication.

An attack monitoring system according to the present invention includes a server device and a plurality of communication devices constituting a wireless communication network. The wireless communication network may be, e.g., a mobile telephone network or a public wireless LAN network. In the case where the wireless communication network is the mobile telephone network, for example, a base station of the mobile telephone network can be the communication device in the present invention. In the case where the wireless communication network is the public wireless LAN network, for example, a wireless LAN access point can be the communication device in the present invention. It will be easily understood that the attack monitoring system can also be applied to other wireless communication networks and devices.

In the attack monitoring system, the server device includes an information acquirer that acquires, in a case where an attack is performed on a mobile unit connected to the wireless communication network, attacker information serving as information related to a transmission source of the attack; and an information sharer that causes the plurality of communication devices to share the attacker information, and each of the plurality of communication devices blocks communication transmitted from the transmission source which corresponds to the shared attacker information.

The server device is a device which collects and manages the information (attacker information) related to the transmission source of the attack performed on the mobile unit connected to the wireless communication network. The attacker information may be any information such as a logical address (e.g., an IP address) or a physical address (e.g., a MAC address) which is used for identifying the transmission source of the attack. The attacker information may be acquired from the attacked mobile unit or, in the case where a device for detecting the attack is present in the network, the attacker information may be acquired from the device.

The attacker information acquired by the server device is shared by the plurality of communication devices constituting the wireless communication network. The sharing may be performed by broadcasting the attacker information, or may also be performed by referring to the attacker information stored in the server device by the plurality of communication devices. When the communication device detects the communication transmitted from the transmission source which corresponds to the shared attacker information, the communication device blocks the communication.

Note that the communication device constituting the wireless communication network may not necessarily perform wireless communication as long as the communication device constitutes part of the wireless communication network. For example, in the case where the target communication network is the mobile telephone network, the communication device may be a base station device disposed in an access network, and may also be a device which is disposed in a core network and is connected to a dedicated network or a wide area network (e.g., the Internet) in a wired manner using optical fibers.

According to this configuration, it becomes possible to efficiently block the second attack performed on the mobile unit in a wireless mobile communication network.

Further, the information acquirer may acquire the attacker information transmitted from the attacked mobile unit.

The mobile unit notifies the server device that the mobile unit is attacked, and the necessity to provide a device for detecting the attack in the wireless communication network is thereby eliminated.

Further, the attack monitoring system may further comprise the mobile unit configured to detect the attack performed on the mobile unit and transmit the attacker information to the server device via the wireless communication network.

Thus, the present invention can also be viewed as the system which further includes the mobile unit having the function of detecting the attack.

Further, the communication device may monitor communication traffic in the wireless communication network, and may block the communication transmitted from the transmission source which corresponds to the attacker information.

The plurality of communication devices constituting the network monitor the communication transmitted from the transmission source which corresponds to the shared attacker information, whereby it becomes possible to block the communication no matter where the attack by the attacker comes from. For example, in the case where the attacker attempts to perform the attack from the inside of a radio access network in the mobile telephone network, it is possible to block the communication in the base station device. In the case where the attacker attempts to perform the attack from the wide area network (e.g., the Internet), it is possible to block the communication at a network gateway. That is, it is possible to block the communication before the communication reaches the radio access network.

Further, the attacker information may be at least one of an IP address and a MAC address of a terminal having performed the attack.

According to this configuration, even in the case where the attacker has moved and performed a handover between the base stations, it is possible to block the communication continuously.

Further, the information sharer may periodically transmit the attacker information to the plurality of communication devices constituting the wireless communication network.

By periodically broadcasting the attacker information to the plurality of communication devices, it is possible to maintain the attacker information of the communication devices at the latest state.

Further, the wireless communication network may be a mobile communication network constituted by a radio access network and a core network, and the communication devices constituting the wireless communication network may include both of a base station device which is disposed in the radio access network and performs wireless communication with the mobile unit, and a communication device which is disposed in the core network.

The communication devices constituting the wireless communication network may include both of the base station device which performs wireless communication with the mobile unit directly, i.e., the communication device constituting the radio access network (RAN), and the communication device which connects the radio access network and the dedicated network (or the wide area network), i.e., the communication device constituting the core network (CN). With this, it becomes possible to apply the present invention to a large-scale wireless communication network such as the mobile telephone network.

Further, the communication device may be a virtual machine which operates by network functions virtualization (NFV).

NFV is a technique for implementing a network function on general-purpose hardware using software. It becomes possible to install the additional communication device according to the present invention at low cost by using the virtual machine.

The present invention in its another aspect provides an attack monitoring device comprising a monitoring unit that detects an attack on a mobile unit connected to a wireless communication network; an acquirer that acquires attacker information serving as information related to a transmission source of the attack; and a sharer that causes a plurality of communication devices constituting the wireless communication network to share the attacker information.

Note that the present invention can be viewed as an attack monitoring system or an attack monitoring device including at least part of the above means. In addition, the present invention can also be viewed as an attack monitoring method performed by the system or the device. The above processes and means can be arbitrarily combined and implemented as long as no technical conflicts occur.

According to the present invention, it is possible to block the unauthorized communication to the mobile unit in the mobile communication network in which a plurality of the mobile units perform wireless communication.

### BRIEF DESCRIPTION OF THE DRAWINGS

FIG. 1 is a configuration diagram of an attack monitoring system according to a first embodiment;

FIG. 2 shows an example of an attacker database of a server device 100;

FIG. 3 is a process flowchart performed by the attack monitoring system according to the first embodiment;

FIG. 4 is a configuration diagram of an attack monitoring system according to a second embodiment; and

FIG. 5 is a process flowchart performed by the attack monitoring system according to the second embodiment.

### DESCRIPTION OF THE EMBODIMENTS

### First Embodiment

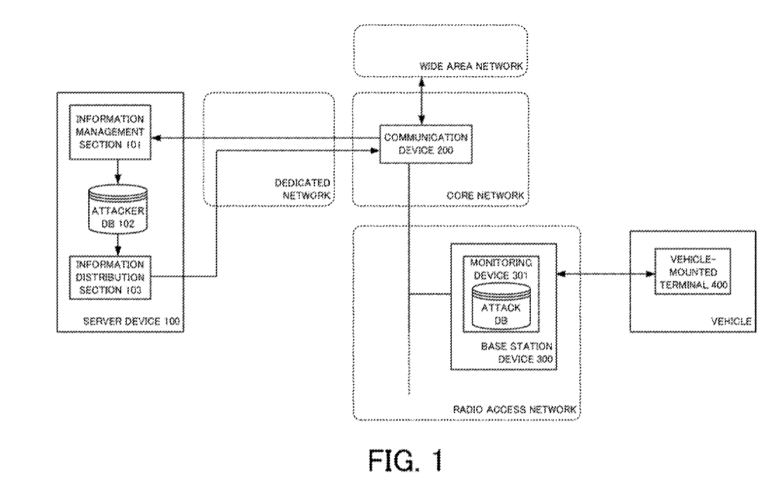

An attack monitoring system according to a first embodiment will be described with reference to FIG. 1 serving as a system configuration diagram. The attack monitoring system according to the first embodiment includes a server device 100, a base station device 300, and a vehicle-mounted terminal (vehicle-mounted wireless communication device) 400 mounted on a vehicle.

The attack monitoring system according to the first embodiment is a system which detects an attack performed on a mobile unit in a mobile telephone network, and blocks the second attack performed by the same attacker. The mobile telephone network serving as the target of the attack monitoring system according to the first embodiment is constituted by a radio access network (RAN) and a core network (CN). The radio access network is constituted by a mobile telephone terminal, a radio base station device and the like. The core network is a backbone network for connecting the radio access network to a dedicated network or a wide area network (the Internet). In the present specification, the core network and the radio access network are collectively referred to as the mobile telephone network.

The vehicle-mounted terminal 400 is a device which has a wireless communication function, and provides a driver with information and assists the driver in driving. The vehicle-mounted terminal 400 is configured to be capable of acquiring information from any information source by accessing the dedicated network or the wide area network via the mobile telephone network. In addition, the vehicle-mounted terminal 400 is configured to be capable of communicating with the server device 100 via the dedicated network. The vehicle-mounted terminal 400 may have a function of performing not only communication via the mobile telephone network but also communication with other vehicles by vehicle-to-vehicle communication or the like.

The vehicle-mounted terminal 400 has a function of detecting an attack performed on the vehicle-mounted terminal 400. For example, the vehicle-mounted terminal 400 detects the attack by measuring traffic load and analyzing the content of a communication packet. A method for detecting the attack is not particularly limited, and it is possible to use any known method. For example, the attack may be detected by detecting a plurality of authentication failures, unauthorized transmission/reception timing of data, and a decoding failure of encrypted data.

The vehicle-mounted terminal 400 has a function of collecting, when the vehicle-mounted terminal 400 detects the attack, information unique to a terminal used by the attacker (hereinafter referred to as an attacker terminal) such as the source address of the communication packet, and transmitting the information to the server device 100 described later. The information unique to the attacker terminal is, e.g., the care-of address of the attacker terminal (a global IP address used for connection to a network) or the like, but may also be information other than the above information. For example, the information unique thereto may include the ID of a radio base station which accommodates the attacker terminal, the type of the attack, the date and time of detection of the attack, and the history of the attack.

Hereinafter, data used by the vehicle-mounted terminal 400 to notify the server device 100 of the attack is referred to as attack detection information. Note that the attack detection information may include information related to the vehicle-mounted terminal 400 (i.e., the attacked vehicle mounted terminal). For example, the ID of the radio base station which accommodates the vehicle-mounted terminal 400 and the care-of address of the vehicle-mounted terminal 400 may be added to the attack detection information.

The server device 100 manages the attack detection information transmitted from the vehicle-mounted terminal 400. The server device 100 receives the attack detection information from a plurality of the vehicle-mounted terminals 400 connected to the mobile telephone network, and manages the attack detection information using a database. In addition, the server device 100 periodically distributes the content of the database (i.e., information related to an identified attacker) to a plurality of communication devices constituting a wireless communication network. Note that information extracted from the database (i.e., a list related to all attackers detected by the system) is referred to as an attacker list.

The server device 100 can be configured as a computer which includes an arithmetic processor such as a CPU, a main storage device such as a RAM, an auxiliary storage device such as an HDD, an SSD, or a DVD-ROM, a wired or wireless communication device, an input device such as a keyboard or a mouse, and a display device such as a display. The server device 100 is not necessarily constituted by one computer, and functions described below may be implemented by cooperation of a plurality of computers.

The server device 100 has an information management section 101, an attacker database 102, and an information distribution section 103. These functions are implemented by execution of an operating system (OS) or an application program by the arithmetic processor of the server device 100.

The information management section 101 is means (an information acquirer) for acquiring and managing the attack detection information transmitted from the vehicle-mounted terminal 400. The information management section 101 can access the attacker database 102 described later, and stores or updates information related to the terminal which has performed the attack on the vehicle-mounted terminal 400 in the case where the attack detection information is transmitted from the vehicle-mounted terminal 400.

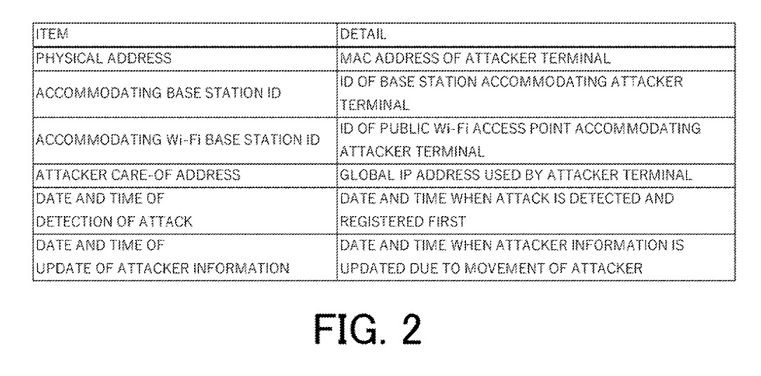

FIG. 2 shows an example of the attacker database 102. The attacker database includes, e.g., the physical address (MAC address) of the attacker terminal, the ID of a base station (e.g., a mobile telephone base station or abase station of a public wireless LAN) which accommodates the attacker terminal, the care-of address of the attacker terminal, the date and time of detection of the attack, and the date and time of update of the information.

It is possible to use, e.g., the physical address acquired from the information recorded in the attacker database as information (key) for uniquely identifying the attacker terminal. For example, in the case where a record in which the corresponding physical address is recorded is present at the timing of transmission of the attack detection information, the corresponding record may be updated (dynamically variable items such as, e.g., the ID of the accommodating base station and the care-of address are updated). In the case where the physical address cannot be acquired, a combination of the ID of the accommodating base station and the care-of address may be used as the key.

Note that, in the case where the information management section 101 has received the attack detection information, the information management section 101 may collect additional information. For example, the information management section 101 may refer to the communication device constituting the core network or the radio access network for information related to the attacker, and store acquired information. For example, the information management section 101 may receive the care-of address of the attacker terminal included in the attack detection information, and determine the ID of the base station device to which the attacker terminal is connected based on the care-of address. In addition, the information management section 101 may refer to the base station device to which the attacker terminal is connected, and acquire the MAC address of the attacker terminal.

The information distribution section 103 is means (an information sharer) for distributing the information recorded in the attacker database 102 to a plurality of the communication devices constituting the wireless communication network. For example, the information distribution section 103 accesses the attacker database 102 to generate the list of the attacker (hereinafter referred to as the attacker list), and transmits the attacker list to each of the communication devices via the dedicated network. In the present embodiment, the attacker list is transmitted to each of a plurality of the base station devices 300 constituting the radio access network.

Next, the base station device 300 will be described.

The base station device 300 is a mobile telephone base station constituting the radio access network. Note that FIG. 1 shows one radio access network and one base station device 300, but a plurality of the radio access networks may be provided, and a plurality of the base station devices 300 may be present in the same radio access network.

The base station device 300 has devices required for wireless communication such as a receiving amplifier, a transmitting amplifier, and a modulation/demodulation device (all not shown), and performs communication with the vehicle-mounted terminal 400 by using known communication methods (e.g., 3G and LTE used in the mobile telephone network) with these devices.

In addition, in the first embodiment, the base station device 300 has a monitoring device 301. The monitoring device 301 is a device which temporarily stores the attacker list distributed by the server device 100, and blocks communication transmitted from a transmission source which corresponds to attacker information present in the list. Note that the monitoring device 301 may be a device having independent hardware, or may also be software which runs on a general-purpose computer.

Note that the base station device 300 is the mobile telephone base station in the first embodiment but, in the case where a network other than the mobile telephone network is used, it is possible to use any wireless communication device as the base station device 300. For example, in the case where a plurality of road side communication units (RSU) are installed along a road, and a mobile communication network in which the plurality of road side communication units communicate with vehicles is used, it is possible to use the roadside communication unit as the base station device 300. Note that the mobile communication network may form the network using wireless communication (vehicle-to-vehicle communication) which is performed between the vehicle-mounted terminals in addition to wireless communication (road-to-vehicle communication) which is performed between the road side communication unit and the vehicle-mounted terminal.

In addition, in the case where the public wireless LAN network is used, it is possible to use the access point of the wireless LAN as the base station device 300.

(Process Flowchart)

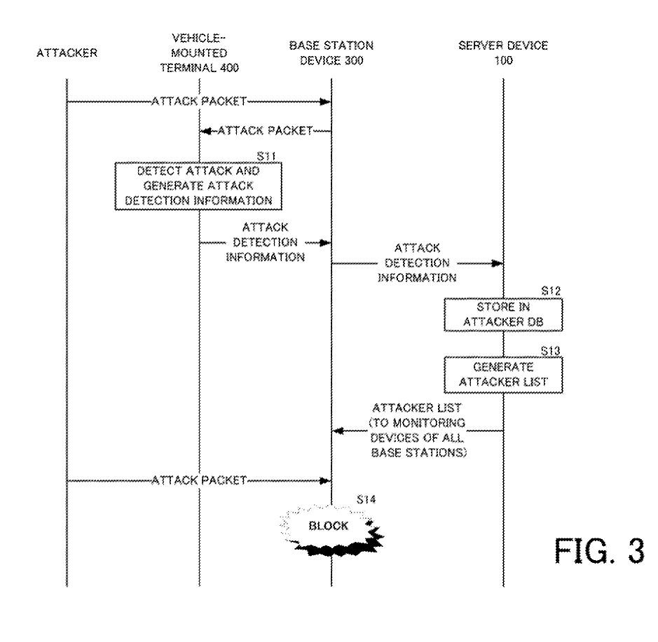

Next, the procedure of processes in the attack monitoring system according to the first embodiment will be described with reference to FIG. 3. Note that, in the first embodiment, the case where the attacker performs an attack from the inside of the radio access network will be described.

When the attacker performs the attack on the vehicle-mounted terminal 400, an attack packet is transmitted to the vehicle-mounted terminal 400 via the base station device 300.

When the vehicle-mounted terminal 400 detects the attack, in Step S11, the attack detection information is transmitted to the server device 10 (the information management section 101). As described above, the attack detection information to be transmitted includes the care-of address of the vehicle-mounted terminal 400 which is the attack target, the care-of address of the attacker terminal, the type of the attack, and the history of the attack. Note that, in the case where the attack target is not the individual vehicle-mounted terminal but the entire network, the attack detection information may include the ID of the attacked radio base station instead of the IP address.

The server device 100 having received the attack detection information updates the attacker database 102 based on the received information in Step S12. Herein, a new record may be generated and added in the case where information related to the same attacker is not present in the attacker database, and an existing record may be updated in the case where the information related to the same attacker is present in the attacker database.

Next, in Step S13, the information distribution section 103 generates the attacker list based on the information recorded in the attacker database 102, and transmits the generated attacker list to each of the base station devices 300 present in the radio access network. The attacker list is the list which has the same items as those of the attacker database. With this, the monitoring devices 301 of all of the base station devices 300 share the list of the same attacker.

Note that Step S13 may be executed periodically independently of the timings of Steps S11 and S12.

Each of the monitoring devices 301 of a plurality of the base station devices 300 temporarily stores the received attacker list and, when the monitoring device 301 detects the communication transmitted from the transmission source which corresponds to the attacker information included in the attacker list, the monitoring device 301 blocks the communication (Step S14). For example, in the case where the communication having, as the transmission source, the MAC address identified as that of the attacker terminal is present, the monitoring device 301 rejects relay of the corresponding packet. With this, the terminal of the attacker cannot connect to the radio access network, and hence the second attack becomes impossible. In addition, all of the base station devices in the radio access network perform the above operation, and hence, even in the case where the attacker terminal performs a handover, it becomes possible to reject all communication.

Note that the MAC address is described by way of example in the above description, but it may be determined whether the attacker terminal is the same attacker terminal by using information other than the MAC address.

Note that, in general, the pattern of the attack through the communication network often changes as time elapses in order to make the attack succeed and reduce the possibility of detection. To cope with this, it is recommended to analyze known attack data and use the analysis in the prediction of the change or devise countermeasures. In the present embodiment, in the case where the monitoring device 301 has blocked the communication, the monitoring device 301 records the content (packet) of the blocked communication in an attack database of the monitoring device 301. The attack database is exported periodically by an administrator of the system, and is used to improve accuracy in attack detection (learning of the attack pattern) and devise countermeasures against the attack. In addition, it is also possible to use the attack database as the evidence of the attack.

As described thus far, according to the first embodiment, in the case where the attack is performed on the vehicle-mounted terminal connected to the radio access network, the information related to the attacker is compiled in the server device 100, and is shared by all of the base station devices constituting the radio access network. According to this configuration, the attacker terminal cannot connect to the radio access network via the base station device, and hence it is possible to prevent the second attack.

Note that, in the case where the second attack is blocked in Step S14, the monitoring device 301 may acquire information related to the current state of the attacker terminal, and transmit the information to the server device 100. For example, the monitoring device 301 may transmit the ID of the base station device which accommodates the attacker terminal (i.e., the base station device of the monitoring device 301) or the care-of address to the server device 100, and the server device 100 may update the attacker database 102 in response to the transmission. According to this configuration, even when the attacker performs the handover, it is possible to track the attacker terminal, and hence it becomes possible to block the unauthorized communication more accurately.

In addition, the update of the attacker database 102 may be performed by using something other than attack as a trigger. For example, all of the base station devices 300 may track the terminal recorded in the attacker list, acquire the information related to the current state of the attacker terminal every time the handover occurs, and transmit the information to the server device 100.

### Second Embodiment

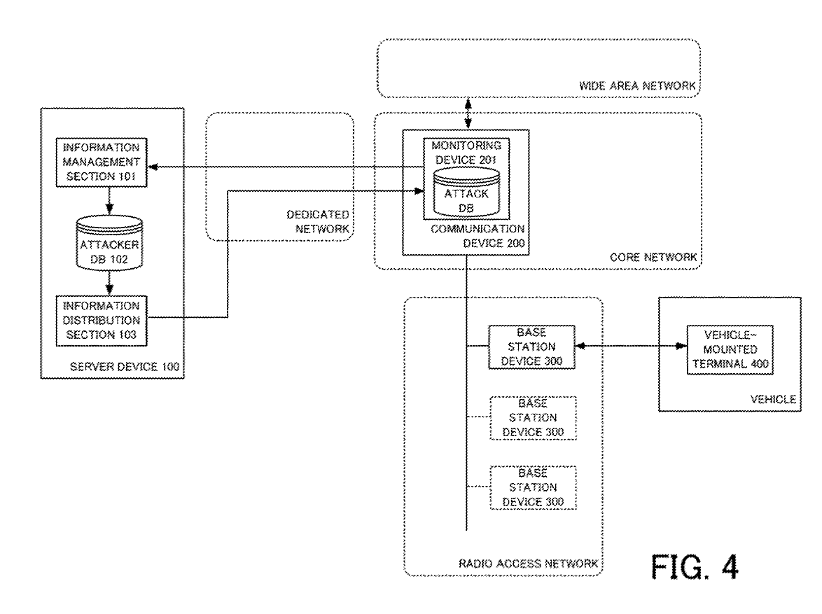

An attack monitoring system according to a second embodiment will be described with reference to FIG. 4 serving as a system configuration diagram. The attack monitoring system according to the second embodiment includes the server device 100, a communication device 200 constituting the core network, and the vehicle-mounted terminal 400 mounted on the vehicle.

In the second embodiment, instead of the base station device 300, the communication device 200 constituting the core network serves as a constituent element. The communication device 200 may be a device (serving gateway: SGW) which performs relay of user data in the core network, or may also be a gateway (packet data network gateway: PGW) which connects the core network and an IP network (e.g., the Internet) connected to the outside. Note that FIG. 4 shows one communication device 200, but a plurality of the communication devices 200 may be provided.

In the second embodiment, the communication device 200 has a monitoring device 201. The monitoring device 201 is a device which temporarily stores the attacker list distributed by the server device 100, and blocks the communication transmitted from the transmission source which corresponds to the attacker information present in the list. Note that each of the communication device 200 and the monitoring device 201 may be a device having independent hardware, or may also be software which runs on a general-purpose computer.

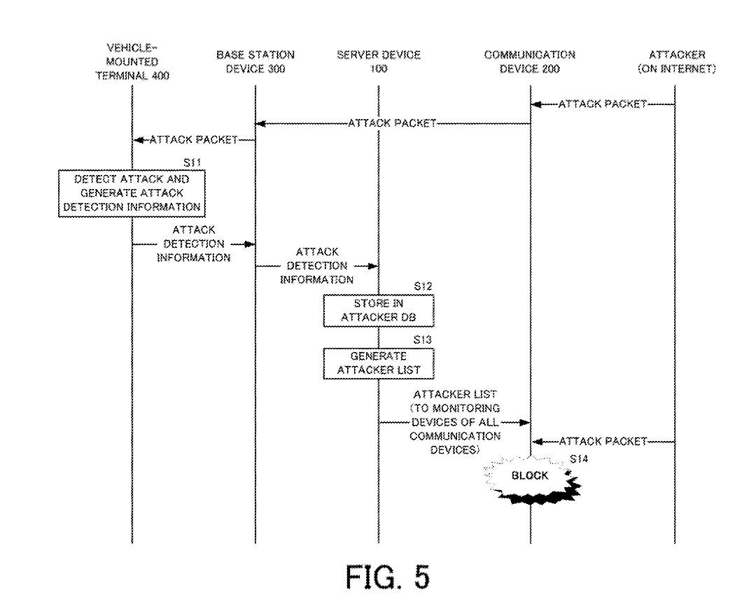

Next, the procedure of processes in the attack monitoring system according to the second embodiment will be described with reference to FIG. 5. Note that, in the second embodiment, the case where the attacker performs the attack from the wide area network (the Internet) will be described.

When the attacker performs the attack on the vehicle-mounted terminal 400, the attack packet is transmitted to the vehicle-mounted terminal 400 via the communication device 200 and the base station device 300.

When the vehicle-mounted terminal 400 detects the attack, similarly to the first embodiment, the attack detection information is transmitted to the server device 100 (the information management section 101) in Step S11. The process in the present step is the same as that in the first embodiment, and hence the detailed description thereof will be omitted.

The server device 100 having received the attack detection information updates the attacker database 102 based on the received information in Step S12. The process in the present step is the same as that in the first embodiment, and hence the detailed description thereof will be omitted.

Next, in Step S13, the information distribution section 103 generates the attacker list based on the information recorded in the attacker database 102, and transmits the generated attacker list to each of the communication devices 200 present in the core network. With this, the monitoring devices 201 of all of the communication devices 200 share the list of the same attacker.

Each of the monitoring devices 201 of a plurality of the communication devices 200 temporarily stores the received attacker list and, when the monitoring device 201 detects the communication transmitted from the transmission source which corresponds to the attacker information included in the attacker list, the monitoring device 201 blocks the communication. For example, in the case where the communication having, as the transmission source, the MAC address identified as that of the attacker terminal is present, the monitoring device 201 rejects the relay of the corresponding packet. With this, the communication transmitted from the terminal of the attacker cannot pass through the core network. In addition, all of the communication devices in the core network perform the above operation, and hence it becomes possible to reject all communication which uses the Internet as the transmission source and is transmitted from the attacker.

Note that, in the case where the monitoring device 201 has blocked the communication, in order to record the kind of the communication attempted in the attack, the monitoring device 201 may record the content (packet) of the blocked communication in the attack database of the monitoring device 201.

As described thus far, according to the second embodiment, in the case where the attack is performed on the vehicle-mounted terminal connected to the radio access network, the information related to the attacker is compiled in the server device 100, and is shared by all of the communication devices constituting the core network. According to this configuration, the attacker terminal cannot connect to the radio access network via the core network, and hence it is possible to prevent the second attack.

Note that, in the second embodiment, the communication device 200 which is hardware is described by way of example, but the communication device 200 may also be implemented by software. For example, the communication device 200 may be implemented by a virtual machine executed in a general-purpose computer. In addition, the communication device 200 may also be disposed on a virtual network (NFV). Thus, by virtualizing the device and the network, it becomes possible to provide an attack monitoring service for each business operator which provides the network.

(Modification)

Each of the above-described embodiments is only exemplary, and the present invention can be appropriately modified and implemented without departing from the gist thereof. For example, the individual embodiments may be combined and implemented.

For example, by combining the first embodiment and the second embodiment, communication traffic may be monitored by using both of the monitoring device 201 and the monitoring device 301, and the unauthorized communication may be blocked.

In addition, in the description of the embodiments, the mobile telephone network is described by way of example, but the wireless communication network which can be used in the present invention is not limited thereto, and any wireless communication network may be used. For example, the public wireless LAN network may be used, or the mobile communication network in which the road side communication unit and the vehicle perform communication may also be used. In addition, other wireless networks may also be used.

Further, in the description of the embodiments, the vehicle (vehicle-mounted terminal) is described as the mobile unit, but the wireless communication device other than the vehicle or the vehicle-mounted terminal may also be used. For example, a smart phone terminal, a movable robot, internet of things (IoT) equipment, or a drone (unmanned aircraft) may serve as the mobile unit.

In addition, the attack to which the present invention applies may be, for example, an attack in which unauthorized access to the mobile unit is attempted, but may also be an attack performed in order to impede network communication of the mobile unit (e.g., a DDOS attack).

Further, the information management section 101 may perform maintenance of the attacker database 102. For example, the information management section 101 may delete the record which has been stored in the attacker database 102 for a predetermined time period from the last attack.

What is claimed is:

1. An attack monitoring system comprising:
a server device; and
a plurality of communication devices constituting a wireless communication network, wherein
the server device includes:
an information acquirer that acquires, in a case where an attack is performed on a mobile unit connected to the wireless communication network, attacker information serving as information related to a transmission source of the attack; and
an information sharer that causes the plurality of communication devices to share the attacker information, and
each of the plurality of communication devices blocks communication transmitted from the transmission source which corresponds to the shared attacker information.

2. The attack monitoring system according to claim 1, wherein
the information acquirer acquires the attacker information transmitted from the attacked mobile unit.

3. The attack monitoring system according to claim 1, further comprising:
the mobile unit configured to detect the attack performed on the mobile unit and transmit the attacker information to the server device via the wireless communication network.

4. The attack monitoring system according to claim 1, wherein
the communication device monitors communication traffic in the wireless communication network, and blocks the communication transmitted from the transmission source which corresponds to the attacker information.

5. The attack monitoring system according to claim 1, wherein
the attacker information is at least one of an IP address and a MAC address of a terminal having performed the attack.

6. The attack monitoring system according to claim 1, wherein
the information sharer periodically transmits the attacker information to the plurality of communication devices constituting the wireless communication network.

7. The attack monitoring system according to claim 1, wherein
the wireless communication network is a mobile communication network constituted by a radio access network and a core network, and
the communication devices constituting the wireless communication network include both of a base station device which is disposed in the radio access network and performs wireless communication with the mobile unit, and a communication device which is disposed in the core network.

8. The attack monitoring system according to claim 1, wherein
the communication device is a virtual machine which operates by network functions virtualization (NFV).

9. An attack monitoring device comprising:
a detector that detects an attack on a mobile unit connected to a wireless communication network;
an information acquirer that acquires attacker information serving as information related to a transmission source of the attack; and
an information sharer that causes a plurality of communication devices constituting the wireless communication network to share the attacker information, to block further attack to the mobile unit.

10. An attack monitoring device according to claim 9, wherein
the information acquirer acquires the attacker information transmitted from the attacked mobile unit.

11. An attack monitoring device according to claim 9, wherein
the attacker information is at least one of an IP address and a MAC address of a terminal having performed the attack.

12. An attack monitoring device according to claim 9, wherein
the information sharer periodically transmits the attacker information to the plurality of communication devices constituting the wireless communication network.

13. An attack monitoring method performed by an attack monitoring device comprising the steps of:
detecting, an attack on a mobile unit connected to a wireless communication network;
acquiring, attacker information serving as information related to a transmission source of the attack; and
causing, a plurality of communication devices constituting the wireless communication network to share the attacker information, to block further attack to the mobile unit.

14. The attack monitoring method according to claim 13, wherein
in the step of acquiring, the attacker information transmitted from the attacked mobile unit is acquired.

15. The attack monitoring method according to claim 13, wherein
the attacker information is at least one of an IP address and a MAC address of a terminal having performed the attack.

16. The attack monitoring method according to claim 13, wherein
in the step of causing, the attacker information is periodically transmitted to the plurality of communication devices constituting the wireless communication network.

17. A non-transitory computer readable storing medium recording a computer program for causing an attack monitoring device to perform the attack monitoring method according to claim 13.
